(19) United States
(12) Patent Application Publication
(10) Pub. No.: US 2009/0279695 A1
(43) Pub. Date: Nov. 12, 2009

(54) ARRANGEMENT FOR AND METHOD OF PROTECTING A DATA PROCESSING DEVICE AGAINST E[LECTRO] M[AGNETIC] RADIATION ATTACKS

(75) Inventor: Gerardus Tarcisius Maria Hubert, Geldrop (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 11/817,811

(22) PCT Filed: Mar. 1, 2006
(86) PCT No.: PCT/IB06/50639

§ 371 Date: Aug. 4, 2008

(30) Foreign Application Priority Data
Mar. 8, 2005 (EP) 05101761.4

(51) Int. Cl. H04L 9/06; G06F 21/00

(52) U.S. Cl. 380/29; 726/17

(57) ABSTRACT

In order to further develop an arrangement for as well as a method of protecting at least one data processing device, in particular at least one embedded system, for example at least one chip card or smart card, against at least one attack, in particular against at least one E[lectro]M[agnetic] radiation attack, the data processing device comprising at least one integrated circuit carrying out calculations, in particular cryptographic operations, wherein E[lectro]M[agnetic] radiation attacks targeted on finding out a private key are to be securely averted, it is proposed to check said calculations with at least one F-proof.

The present invention relates in general to the technical field of impeding crypto analysis, in particular of protecting at least one data processing device against at least one E[lectro]M[agnetic] radiation attack.

Specifically, the present invention relates to an arrangement for and a method of protecting at least one data processing device, in particular at least one embedded system, for example at least one chip card or smart card, against at least one attack, in particular against at least one E[lectro]M[agnetic] radiation attack, the data processing device comprising at least one integrated circuit carrying out calculations, in particular cryptographic operations.

Data processing devices, in particular embedded systems, such as chip cards or smart cards, use P[ublic]K[ey]I[nfrastructure] systems for exchanging keys and have to be protected against several forms of attacks targeted on finding out the private key. One such attack is to influence the calculation, in particular the cryptographic operation, by directing
one or more light sources or
some kind of E[lectro]M[agnetic] radiation source(s) on the naked (and thus light-sensitive) chip.

In order to protect an integrated circuit against readout of sensitive data by way of mechanical tips or by way of electronic rays or laser rays, prior art document DE 40 18 688 A1 proposes to provide the sensitive components of the integrated circuit with a protective layer and to periodically check whether the capacity, the inductivity or the resistance of this protective layer is changed due to an intrusion from outside.

Prior art document JP 11-008616 A discloses to enhance the security of an I[ntegrated]C[ircuit] card against attack taking advantage of failure of the IC card conducting signature generating processing at high speed by using the Chinese remainder theorem.

To provide an electric or electronic circuit arrangement and a method of protecting a chip arrangement from abuse and/or from manipulation, a detector unit, whose output voltage is a measure of the incidence of light on the detector unit, and a comparator unit preceded by the detector unit provided for comparing the output voltage of the detector unit with a reference voltage, are arranged according to prior art document EP 1 233 372 A1. In this way, the data and/or the functions of the chip arrangement to be protected can be temporarily or permanently obstructed and/or erased and/or blocked and/or interrupted in the case of a failure message occurring during comparison of the output voltage of the detector unit with the reference voltage.

Prior art document EP 1 326 203 A2 relates to a method and an arrangement for protecting digital parts of circuits, which method and arrangement may be used in particular to protect memory units in such digital circuits, and particularly in smart card controllers containing secret data against attacks in which the approach adopted is to change digital parts of circuits, and particularly the digital part of the smart card controller, to an undefined state by brief voltage drops, for example by light-flash attacks.

Prior art document GB 2 319 150 A proposes an authentication method with an associated security method. The authentication method comprises the steps of obtaining a calculated result from a random number subjected to a secret key algorithm. The security method includes steps of calculating a test result from a reference random number subjected to the secret key algorithm, of comparing the test result with a reference result, and of ensuring that the calculated result is transmitted only when the test result is identical to the reference result.

Starting from the disadvantages and shortcomings as described above and taking the prior art as discussed into account, an object of the present invention is to further develop an arrangement as well as a method of the kind as described in the technical field in order to be capable of securely averting E[lectro]M[agnetic] radiation attacks targeted on finding out a private key.

The object of the present invention is achieved by an arrangement comprising the features of claim 1 as well as by a method comprising the features of claim 6. Advantageous embodiments and expedient improvements of the present invention are disclosed in the respective dependent claims.

The present invention is principally based on the idea to use an F-calculation and/or an F-proof for chip card or smart card protection against E[lectro]M[agnetic] radiation attacks, in particular against light attacks, for instance against light-flash attacks; thereby, the security of the I[ntegrated]C[ircuit] card against such attacks taking advantage of failure of the IC card is significantly enhanced.

Using the F-calculation and/or an F-check (so-called F-proof) is a more generalized approach than the random number calculation as revealed in prior art document GB 2 319 150 A because the present invention also works fine with a multiple of four bits.

Such E[lectro]M[agnetic] radiation attacks try to find out the private key by influencing the calculation by directing a light source or an other EM radiation source onto the chip. To protect the embedded system, in particular the chip card or the smart card, an F-proof checks the calculation. The F-proof is for the hexadecimal system and is similar to the 9-proof for the decimal system.

For the decimal system, this 9-proof is known. When two numbers are multiplied, the digits of each number are added, both sums are multiplied, the result is divided by 9 and the remainder is kept. Then the result of the multiplication is taken, its digits are summed, also divided by 9 and the remainder is kept. The 9-proof states that both remainders are the same.

For the hexadecimal system, the F-proof is a comparable proof. This F-proof might already be known for GF(p) but not for GF(2ⁿ) for which the present invention describes also a proof. In this context, an architecture is said to be unified if this architecture is able to work with operands in both prime (p) extension fields and binary (2ⁿ) extension fields:

If p is a prime, the integers modulo p form a field with p elements, denoted by GF(p). A finite field is a field with a finite field order, i.e. a finite number of elements, also called a G[alois]F[ield] or an GF. The order of a finite field is always a prime or a power of a prime. For each prime power, there exists exactly one (with the usual caveat that “exactly one” means “exactly one up to an isomorphism”) finite field GF( ). GF(p) is called the prime field of order p, and is the field of residue classes modulo p

When n>1, GF( ) can be represented as the field of equivalence classes of polynomials whose coefficients belong to GF(p). Any irreducible polynomial of degree n yields the same field up to an isomorphism.

According to a particularly inventive refinement of the present invention access to the embedded system is refused when the F-proof finds an error in the calculation. In this context, the F-calculation checks the calculation, in particular the cryptographic operation, by the so-called F-proof. When the F-calculation finds an error, it refuses to give results.

Such F-calculation or F-check is effective because a light attack or E[lectro]M[agnetic] radiation attack is course; neither the place nor the time of such attack is fine. For this reason the attacker is neither able to attack a calculation on the exact moment nor exactly the required part, i.e. the location of the gates. Most often, a trial-and-error method is used for such attacks.

The present invention further relates to a data processing device, in particular to an embedded system, for example to a chip card or to a smart card, comprising at least one integrated circuit carrying out calculations, in particular cryptographic operations, wherein the integrated circuit is protected against at least one attack, in particular against at least one E[lectro]M[agnetic] radiation attack, by checking said calculations with at least one F-proof.

The present invention finally relates to the use of at least one arrangement as described above and/or of the method as described above in at least one data processing device as described above.

As already discussed above, there are several options to embody as well as to improve the teaching of the present invention in an advantageous manner. To this aim, reference is made to the claims respectively dependent on claim 1 and on claim 6; further improvements, features and advantages of the present invention are explained below in more detail with reference to a preferred embodiment by way of example and to the accompanying drawings where

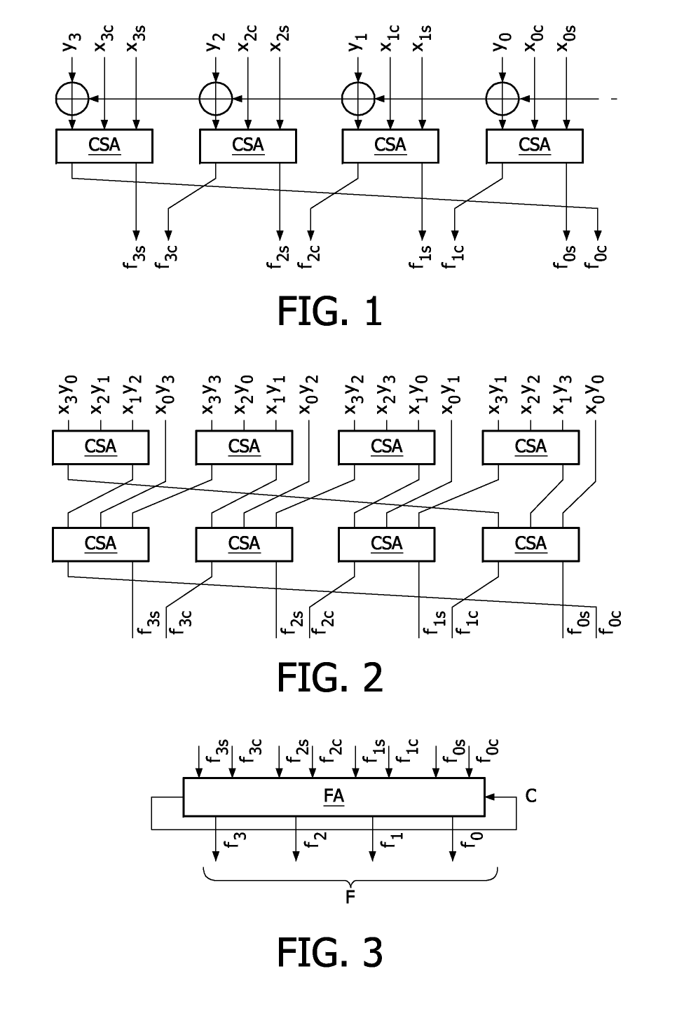

FIG. 1 schematically shows an embodiment of four C[arry-]S[ave]A[dder]s being part of the present invention;

FIG. 2 schematically shows an embodiment of eight interconnected C[arry-]S[ave]A[dder]s being part of the present invention; and

FIG. 3 schematically shows an embodiment of a full adder being part of the present invention.

The same reference numerals are used for corresponding parts in FIG. 1 to FIG. 3.

The embodiment of a data processing device, namely an embedded system in the form of a chip card or of a smart card comprising an I[ntegrated]C[ircuit] carrying out cryptographic operations refers to a P[ublic]K[ey]I[nfrastructure] system and works according to the method of the present invention, i.e. is protected from abuse and/or from manipulation.

The cryptographic calculations of the integrated circuit can be based on the R[ivest-]S[hamir-]A[dleman] algorithm (cf. prior art document U.S. Pat. No. 4,405,829 or prior art article “A Method for Obtaining Digital Signatures and Public-Key Cryptosystems” by Ron Rivest, Adi Shamir, and Len Adleman in Communications of the ACM, 21 (2), pages 120 to 126, February 1978) calculating for encryption C=M^{e} mod(N) wherein
M is the message to be encrypted,
N=p.q,
e is coprime to (p−1)(q−1),
d is such that x^{ed} mod [(p−1)(q−1)]=1;

the decryption calculates M=C^{d} mod(N).

One of the ways to calculate M^{e} (or C^{d}) is the following:
starting with R=M;
scanning the exponent e from left to right:
always calculating R=R² mod(N);
when the scanned bit of e=1, moreover R=R·M mod(N) is calculated.

Thus, the calculation consists of a number of squarings and multiplications. For the reduction, the modulus N is a number of times (Q) subtracted or added from the result.

The multiplication is in general:

R=X·Y−Q·N with X=R and Y=M;

at the start, the F(M) and the F(N) are calculated and stored as F_{M} and F_{N}; since X (=R) is the result of a previous calculation, F(X) is also known and stored as F_{X}.

The F-proof calculates:

F=F_{X}·F_{Y}−F(Q)·F_{N} and the F(R), i.e. from the result.

Then the F-proof checks: F=F(R). The value is stored for use in the next check.

F(Q) is calculated during the reduction when the factor Q is computed.

The squaring is in general:

R=X²−Q·N with X=R;

the F-proof checks: F(R)=F_{X}²−F(Q)·F_{N}.

For E[lliptic]C[urve]C[ryptography] (cf. prior art article “A Reconfigurable System on Chip Implementation for Elliptic Curve Cryptography over GF(2n)” by M. Ernst, M. Jung, F. Madlener, et al., pages 381 to 399), an elliptic curve and a point P on that curve are chosen.

At a first instance A, a random number a is chosen; a·P is calculated and sent as public key to a second instance B. At this instance B, also a random number b is chosen; b·P is calculated and sent as public key to the first instance B. Then the first instance A calculates K=a·(b·P) and the second instance B calculates K′=b·(a·P). Now K=K′ and this is the common secret of the two instances A and B.

The basic operation is the multiplication of a point P by a scalar a. This is a repeated point addition X=aP=P+P+ . . . +P (a times):
starting with R=P;
scanning the scalar a from left to right:
always calculating R=2R mod(N) (so-called point doubling);
when the scanned bit of a=1, moreover R=R+P mod(N) is calculated (so-called point addition).

The algorithm for the so-called point doubling and the algorithm for the so-called point addition use operations as X·Y±Z mod(N) and X²±Z mod(N) (like the R[ivest-]S[hamir-]A[dleman] algorithm but also a third operand Z is added or subtracted).

In the same way as for the R[ivest-]S[hamir-]A[dleman] algorithm, the F-proof checks:
F(R)=F_{X}·F_{Y}±F_{Z}−F(Q)·F_{N};
F(R)=F_{X}²±F_{Z}−F(Q)·F_{N}.

The point doubling algorithm and the point addition algorithm require also an inversion operation, which calculates X⁻¹ [X·X⁻¹ mod(N)=1]; this operation can also be checked by the F-proof (cf. below), namely by the so-called F-proof for inversion:

Let X⁻¹ be the inverse of X mod(N), i.e. X·X⁻¹=1 mod(N).

It is assumed that F(X) has been calculated before; after the calculation of the inversion of X, i.e. after the calculation of X⁻¹, F(X⁻¹) mod(F) is calculated.

Now, the calculation of the inverse X⁻¹ can easily be checked by calculating F(X·X⁻¹) mod(F)=F(X)·F(X⁻¹) mod(F)=1.

If the result is unequal to 1, then the calculation of the inverse X⁻¹ was incorrect, in particular because of some kind of attack, for example because of some kind of E[lectro]M[agnetic] radiation attack.

This check, i.e. this F-proof for inversion costs much less calculation power than the multiplication of X and X⁻¹ mod(N), which also should have the result 1. Moreover, the value of F(X⁻¹) is also required for the remaining checks. Thus, only the calculation of F(X)·F(X⁻¹) mod(F) is additional.

For the F-proof itself, there are the following definitions and properties:
Let for the Galois Field GF(p):
X=xₙ₋₁Bⁿ⁻¹+xₙ₋₂Bⁿ⁻²+ . . . +x₀;
B=2⁴;
F=B−1 for GF(p).
Let for the Galois Field GF(2ⁿ):
X=xₙ₋₁Bⁿ⁻¹⊕xₙ₋₂Bⁿ⁻²⊕ . . . ⊕x₀
B=a⁴;
F=B⊕1 for GF(2ⁿ).
With the definition F(X)=X mod(F), the first lemma is:
F(X)=xₙ₋₁+xₙ₋₂+ . . . +x₀ mod(F).

Proof for GF(p):

$$\begin{matrix}F ( X ) = {x}_{n - 1} {B}^{n - 1} + {x}_{n - 2} {B}^{n - 2} + … + {x}_{0} mod ( B - 1 ) \\ // subtract B - 1 {x}_{n - 1} {B}^{n - 2} times \\ = ( {x}_{n - 1} + {x}_{n - 2} ) {B}^{n - 2} + … + {x}_{0} mod ( B - 1 ) \\ // subtract B - 1 ( {x}_{n - 1} + {x}_{n - 2} ) {B}^{n - 3} times \\ = ( {x}_{n - 1} + {x}_{n - 2} + {x}_{n - 3} ) {B}^{n - 3} + … + {x}_{0} mod ( B - 1 ) \\ // subtract B - 1 ( {x}_{n - 1} + {x}_{n - 2} + {x}_{n - 3} ) {B}^{n - 4} times\end{matrix}$$

Repeating this procedure, one gets F(X)=xₙ₋₁+xₙ₋₂+ . . . +x₀ mod(F).

The proof for GF(2ⁿ) is done in the same way by adding a⁴⊕1 instead of subtracting B−1.

The second lemma is:
F(X+Y)=F(X)+F(Y) mod(F)

Proof for GF(p):

$$\begin{matrix}F ( X + Y ) = F ( X ) + F ( Y ) mod ( F ) \\ = {x}_{n - 1} {B}^{n - 1} + {x}_{n - 2} {B}^{n - 2} + … + {x}_{0} + ( \begin{matrix}\begin{matrix}{y}_{n - 1} {B}^{n - 1} + \\ {y}_{n - 2} {B}^{n - 2} +\end{matrix} \\ … + {y}_{0}\end{matrix} ) \\ mod ( B - 1 ) \\ = ( {x}_{n - 1} + {y}_{n - 1} ) {B}^{n - 1} + ( {x}_{n - 2} + {y}_{n - 2} ) {B}^{n - 2} + … + \\ ( {x}_{0} + {y}_{0} ) mod ( B - 1 ) \\ = {x}_{n - 1} + {y}_{n - 1} + {x}_{n - 2} + {y}_{n - 2} + … + ( {x}_{0} + {y}_{0} ) mod ( B - 1 ) \\ = {x}_{n - 1} + {x}_{n - 2} + … + {x}_{0} + {y}_{n - 1} + {y}_{n - 2} + … + {y}_{0} \\ = F ( X ) + F ( Y )\end{matrix}$$

The proof for GF(2ⁿ) is done in the same way by replacing + by ⊕.

The third lemma is:
F(X−Y)=F(X)−F(Y) mod(F)

Proof for GF(p):

$$\begin{matrix}F ( X - Y ) = F ( X ) - F ( Y ) mod ( F ) \\ = {x}_{n - 1} {B}^{n - 1} + {x}_{n - 2} {B}^{n - 2} + … + {x}_{0} - ( \begin{matrix}\begin{matrix}{y}_{n - 1} {B}^{n - 1} + \\ {y}_{n - 2} {B}^{n - 2} +\end{matrix} \\ … + {y}_{0}\end{matrix} ) \\ mod ( B - 1 ) \\ = ( {x}_{n - 1} - {y}_{n - 1} ) {B}^{n - 1} + ( {x}_{n - 2} - {y}_{n - 2} ) {B}^{n - 2} + … + \\ ( {x}_{0} - {y}_{0} ) mod ( B - 1 ) \\ = {x}_{n - 1} - {y}_{n - 1} + {x}_{n - 2} + {y}_{n - 2} + … + ( {x}_{0} - {y}_{0} ) mod ( B - 1 ) \\ = {x}_{n - 1} + {x}_{n - 2} + … + {x}_{0} - ( {y}_{n - 1} + {y}_{n - 2} + … + {y}_{0} ) \\ = F ( X ) - F ( Y )\end{matrix}$$

There is no such operation in GF(2ⁿ).

The fourth lemma is:
F(X·Y)=F(X)·F(Y) mod(F)

Proof for GF(p):

$$\begin{matrix} \begin{matrix}F ( X \cdot Y ) = F ( X ) \cdot F ( Y ) mod ( F ) \\ = ( \begin{matrix}\begin{matrix}{x}_{n - 1} {B}^{n - 1} + \\ {x}_{n - 2} {B}^{n - 2} +\end{matrix} \\ … + {x}_{0}\end{matrix} ) ( \begin{matrix}\begin{matrix}{y}_{n - 1} {B}^{n - 1} + \\ {y}_{n - 2} {B}^{n - 2} +\end{matrix} \\ … + {y}_{0}\end{matrix} ) mod ( B - 1 ) \\ = {x}_{n - 1} {B}^{n - 1} ( {y}_{n - 1} {B}^{n - 1} + {y}_{n - 2} {B}^{n - 2} + … + {y}_{0} ) + \\ + {x}_{n - 2} {B}^{n - 2} ( {y}_{n - 1} {B}^{n - 1} + {y}_{n - 2} {B}^{n - 2} + … + {y}_{0} ) + \\ + … + \\ + {x}_{0} ( {y}_{n - 1} {B}^{n - 1} + {y}_{n - 2} {B}^{n - 2} + … + {y}_{0} ) mod ( B - 1 ) \\ = {B}^{n - 1} ( {x}_{n - 1} {y}_{n - 1} {B}^{n - 1} + {x}_{n - 1} {y}_{n - 2} {B}^{n - 2} + … + {x}_{n - 1} {y}_{0} ) + \\ + {B}^{n - 2} ( {x}_{n - 2} {y}_{n - 1} {B}^{n - 1} + {x}_{n - 2} {y}_{n - 2} {B}^{n - 2} + … + {x}_{n - 2} {y}_{0} ) + \\ + {B}^{n - 3} ( {x}_{n - 3} {y}_{n - 1} {B}^{n - 1} + {x}_{n - 3} {B}^{n - 2} + … + {x}_{n - 3} {y}_{0} ) + \\ + … + \\ + {B}^{0} ( {x}_{0} {y}_{n - 1} {B}^{n - 1} + {x}_{0} {y}_{0} ) mod ( B - 1 ) \\ = {B}^{n - 1} ( \begin{matrix}\begin{matrix}{x}_{n - 1} {y}_{n - 1} + \\ {x}_{n - 1} {y}_{n - 2} +\end{matrix} \\ … + {x}_{n - 1} {y}_{0}\end{matrix} ) + // according to first lemma \\ + {B}^{n - 2} ( {x}_{n - 2} {y}_{n - 1} + {x}_{n - 2} {y}_{n - 2} + … + {x}_{n - 2} {y}_{0} ) + \\ + {B}^{n - 3} ( {x}_{n - 3} {y}_{n - 1} + {x}_{n - 3} {y}_{n - 2} + … + {x}_{n - 3} {y}_{0} ) + \\ + … + \\ + {B}^{0} ( {x}_{0} {y}_{n - 1} + {x}_{0} {y}_{n - 2} + … + {x}_{0} {y}_{0} ) mod ( B - 1 ) \\ = {x}_{n - 1}^{′} {B}^{n - 1} + {x}_{n - 2}^{′} {B}^{n - 2} + … + {x}_{0}^{′}\end{matrix} & \\ with \\ {x}_{i - 1}^{′} = {x}_{i - 1} ( {y}_{n - 1} + {y}_{n - 2} + … + {y}_{0} ) for i = 0 , 1 , … , n - 1 \\ F ( X \cdot Y ) = {x}_{n - 1}^{′} + {x}_{n - 2}^{′} + … + {x}_{0}^{′} \\ = ( {x}_{n - 1} + {x}_{n - 2} + … + {x}_{0} ) ( {y}_{n - 1} + {y}_{n - 2} + … + {y}_{0} ) \\ = F ( X ) F ( Y ) & \end{matrix}$$

The proof for GF(2ⁿ) is done in the same way by replacing + by ⊕.

Regarding the implementation of the present invention, the notation x=F(X) and y=F(Y) is used; x and y consist of four bits (nibble).

The summation mod(F) for GF(p) is as follows:
F(X+Y)=F(x)+F(y) mod(F)=x+y mod(F)

Since a number of consecutive operations has to be done, one of the operands (here: x) will be in carry-save form. When the outcome is F, it is left instead of reducing it to zero.

$$\begin{matrix}F ( x ) & \\ & \\ F ( y ) & \\ & \\ & \\ F ( {x}^{′} ) & \\ & {x}_{4 {c}^{′}}\end{matrix} \begin{matrix}{x}_{3 s} & {x}_{2 s} & {x}_{1 s} & {x}_{0 s} \\ {x}_{3 c} & {x}_{2 c} & {x}_{1 c} & {x}_{0 c} \\ {y}_{3} & {y}_{2} & {y}_{1} & {y}_{0} \\ & & & \\ & & & \\ {x}_{3 s}^{′} & {x}_{2 s}^{′} & {x}_{1 s}^{′} & {x}_{0 s}^{′} \\ {x}_{3 c}^{′} & {x}_{2 c}^{′} & {x}_{1 c}^{′} & 0\end{matrix} + \\ {x}_{4 {c}^{′}} is the carry of the summation of {x}_{3 s} + {x}_{3 c} + {y}_{3} .$$

The outcome has to be reduced mod(F). Thus when x_{4c′}=1, F is subtracted F or its 2's complement is added, which is 1. Thus, x_{4c′} is added to the L[east]S[ignificant]B[it]. However, the addition is postponed and stored in the place of x_{0c}, which is zero. Thus, the following result is obtained, with F(x′)=F(x)+F(y)=F(x+y):

$$F ( {x}^{′} ) \begin{matrix}{x}_{3 s}^{′} & {x}_{2 s}^{′} & {x}_{1 s}^{′} & {x}_{0 s}^{′} \\ {x}_{3 c}^{′} & {x}_{2 c}^{′} & {x}_{1 c}^{′} & {x}_{4 c}^{′}\end{matrix}$$

To summarize, a normal carry-save addition is performed and the carry is stored as the L[east]S[ignificant]B[it] carry (at bit 0 instead at bit 4).

For GF(2ⁿ), all carry terms (with index c) are zero. The addition is a simple bit wise EX[clusive]OR.

In case of addition, the inputs are not inverted, but in case of subtraction the inputs are inverted by the EX[clusive]ORs (cf. FIG. 1: addition and subtraction).

When the outputs are fed back via registers to the x-inputs and when the y-inputs are consecutive nibbles of the Y-operand, the circuit computes the F(Y), i.e. of the complete operand in steps of four bits.

The subtraction mod(F) is as follows:

F(X−Y)=F(X)−F(Y) mod(F)=x−y mod(F) with x−y=−B+x+(B−y−1)+1 mod(F). Adding F=B−1, x−y=x+(B−y−1)=x+y′ with y′⊕“1111” is obtained.
Instead of subtraction, F(X) and the bit wise inverse of F(Y) is added.
For GF(2ⁿ), subtraction does not exist.
The multiplication mod(F) for GF(p) is as follows:
F(X·Y)=F(X)·F(Y) mod(F)=x·y mod(F).
First, doubling mod(F) is investigated:
F(2x)=2x₃2³+2x₂2²+2x₁2¹+2x₀2⁰ mod(F)=x₃2⁴+x₂2³+x₁2²+x₀2¹.
This is reduced by subtraction x₃(B−1)=x₃(2⁴−1):
F(2x)=x₃+x₂2³+x₁2²+x₀2¹.

Thus, the doubling mod(F) is the same as a one bit left rotation. In the same way, it can be proven that multiplying by 2ⁿ mod(F) is the same as an n bit left rotation. Multiplying is the same as adding a number of shifted operands, so it is rotated instead.

$$\begin{matrix}F ( {x}^{′} ) \\ \end{matrix} \begin{matrix}{x}_{3 s}^{′} & {x}_{2 s}^{′} & {x}_{1 s}^{′} & {x}_{0 s}^{′} \\ {x}_{3 c}^{′} & {x}_{2 c}^{′} & {x}_{1 c}^{′} & {x}_{4 {c}^{′}}\end{matrix}$$

This is done by carry-save adders CSA (cf. FIG. 2). A C[arry-]S[ave]A[dder] converts the problem of adding three numbers together into a problem of adding two numbers together. If nine numbers are to be added together, three C[arry-]S[ave]A[dder]s can be used in order to reduce the nine numbers to six numbers; then, these six numbers can be reduced to four numbers. In this context, the carry-in is taken from the preceding calculation, and the carry-out is stored for the subsequent calculation.

The advantage of the CSA computation technique is its quickness because of significantly shorter multiplication steps and because there is no carry propagation during the multiplication, i.e. the carries are saved for later. A carry-save adder is a basic example of a computation technique called redundant digit representation. The basic motivation for redundant digit representation is that
computation is often easier in different representations of a number being not compact and
using binary representation for intermediate results requires extra logic to make the representation compact.

Accordingly, three products are added giving a carry and sum result. As shown above under summation mod(F), the upper carry becomes bit zero. Then, the fourth product is added; this gives again a carry and sum result; again, the upper carry becomes bit zero: f_{0c}.

For GF(2ⁿ), all carry terms are suppressed, as usual.

Regarding the squaring mod(F), beside the possibility of using the multiplication function with x=y, F(X²), the computation logic for this function is quite simple. F(X²) is found in the following table showing the squaring of F(x) and can easily be synthesized:

| F(x) | GF(p) | GF(2ⁿ) |
|---|---|---|
| 0 | 0 | 0 |
| 1 | 1 | 1 |
| 2 | 4 | 4 |
| 3 | 9 | 5 |
| 4 | 1 | 1 |
| 5 | A | 0 |
| 6 | 6 | 5 |
| 7 | 4 | 4 |
| 8 | 4 | 4 |
| 9 | 6 | 5 |
| A | A | 0 |
| B | 1 | 1 |
| C | 9 | 5 |
| D | 4 | 4 |
| E | 1 | 1 |
| F | 0 | 0 |

The result does not change when all input bits are inverted.

At the end, the result has to be converted from carry-sum form to normal by a full adder FA (cf. FIG. 3) being independent of the carry-save adder CSA. The outgoing carry is first calculated and added as input carry:
Let generator Gᵢ=fᵢₛf_{ic} and propagator Pᵢ=f₃ₓ⊕f_{ic};
then C=G₃+P₃G₂+P₃P₂G₁+P₃P₂P₁G₀.
For GF(2ⁿ), all carry-terms are suppressed, as usual.

1. An arrangement for protecting at least one data processing device, in particular at least one embedded system, for example at least one chip card or smart card, against at least one attack, in particular against at least one E[lectro]M[agnetic] radiation attack, the data processing device comprising at least one integrated circuit carrying out calculations, in particular cryptographic operations, characterized by checking said calculations with at least one F-proof.

2. The arrangement according to claim 1, characterized in that the F-proof is designed for the hexadecimal system.

3. The arrangement according to claim 1, characterized in that access to the data processing device is refused when the F-proof finds at least one error in said calculations.

4. The arrangement according to claim 1, characterized in that said calculations are based on the R[ivest-]S[hamir-]A[dleman] algorithm and/or on the E [Hip tic] C [urve] C [ryptography] algorithm.

5. A data processing device, in particular an embedded system, for example a chip card or a smart card, comprising at least one integrated circuit carrying out calculations, in particular cryptographic operations, characterized by protecting the integrated circuit against at least one attack, in particular against at least one E[lectro]M[agnetic] radiation attack, by checking said calculations with at least one F-proof.

6. A method of protecting at least one data processing device, in particular at least one embedded system, for example at least one chip card or smart card, against at least one attack, in particular against at least one E[lectro]M[agnetic] radiation attack, the data processing device, in particular at least one integrated circuit of the data processing device, carrying out calculations, in particular cryptographic operations, characterized by checking said calculations with at least one F-proof.

7. The method according to claim 6, characterized in that the F-proof is designed for the hexadecimal system.

8. The method according to claim 6, characterized in that access to the data processing device is refused when the F-proof finds at least one error in said calculations.

9. The method according to claim 6, characterized in that said calculations are based on the R[ivest-]S[hamir-]A[dleman] algorithm and/or on the
E [Hip tic] C [urve] C [ryptography] algorithm.

10. Use of at least one arrangement according to claim 1 in at least one data processing device in particular an embedded system, for example a chip card or a smart card, comprising at least one integrated circuit carrying out calculations, in particular cryptographic operations, characterized by protecting the integrated circuit against at least one attack, in particular against at least one E[lectro]M[agnetic] radiation attack by checking said calculations with at least one F-proof.
